(19) United States
(12) Patent Application Publication
(10) Pub. No.: US 2006/0203747 A1
(43) Pub. Date: Sep. 14, 2006

(54) Network topology systems and methods

(75) Inventors: Gregory Wright, Stittsville (CA); Mehdi Arashmid Akhavain Mohammadi, Nepean (CA)

Correspondence Address: Alan M. Weisberg;CHRISTOPHER & WEISBERG, P.A., Suite 2040, 200 East Las Olas Boulevard, Fort Lauderdale, FL, 33301, US

(73) Assignee: NORTEL NETWORKS LIMITED

(21) Appl. No.: 11/302,826

(22) Filed: Dec. 14, 2005

Related U.S. Application Data
(60) Provisional application No. 60/661,278, filed on Mar. 11, 2005.

(51) Int. Cl. H04L 12/28

(52) U.S. Cl. 370/254

(57) ABSTRACT

A method for creating a logical network topology in a communication network having a plurality of network nodes. Within the communication network, one or more logical network paths are identified between nodes of the communication network. Each logical path is assigned one or more identification tags. A network device at each network node receives primary layer network information from at least one neighboring network node. The primary layer network information can include at least one identification tag, identifying a logical path within the communications network, and a destination address. Each network node can determine a logical network topology using the received primary layer network information.

### CROSS-REFERENCE TO RELATED APPLICATIONS

This application is based on and claims priority to U.S. Provisional Patent Application No. 60/661,278, entitled NETWORK TOPOLOGY SYSTEMS AND METHODS, filed Mar. 11, 2005, the entire contents of which is incorporated herein by reference.

### STATEMENT REGARDING FEDERALLY SPONSORED RESEARCH OR DEVELOPMENT

n/a

### BACKGROUND OF THE INVENTION

1. Statement of the Technical Field

This invention generally relates to the field of packet communication networks and, more specifically, to logical network topology creation and logical path identification.

2. Description of the Related Art

In a data communication network, data packets travel from one router to the next, wherein each router makes an independent forwarding decision for that data packet. Each router analyzes the packet's header and runs a network layer routing algorithm. Each router independently chooses a next hop for the data packet, based on its analysis of the packet's header and the results of running the routing algorithm.

A well known protocol for data packet communication networks is Multi-Protocol Label Switching (MPLS). In an MPLS network, incoming data packets are assigned a “label” by a “Label Edge Router (LER)”. Labels are short, fixed-length physically contiguous identifiers that are used to identify a Forwarding Equivalence Class (FEC). The label assigned to a particular packet represents the FEC to which that packet is assigned.

Packets are forwarded along a Label Switch Path (LSP), where each Label Switch Router (LSR) makes forwarding decisions based solely on the contents of the label. At each hop, the LSR strips off the existing label and applies a new label, which tells the next hop how and where to forward the packet. LSPs are established by network operators for a variety of purposes, such as to guarantee a certain level of performance, to route around network congestion, or to create logical Internet Protocol (IP) tunnels, for network-based Virtual Private Networks (VPNs).

A fundamental property of MPLS is label stacking. Label stacking is a mechanism that enables hierarchical switching. At the base of this hierarchy is an underlying network. In an MPLS network, the underlying network is the IP network.

MPLS tunnels form logical paths through an underlying network. A logical network typically includes a set of logical paths. A Packet Switched Network (PSN) tunnel has been characterized within the Internet Engineering Task Force (IETF) as a link or path across an underlying network. The IP Border Gateway Protocol (BGP) VPN [RFC2547] and Pseudo-Wire Emulation (PWE) standards, both of which are hereby incorporated by reference, are examples of using PSN tunnels to provide a logical path between service endpoints.

Unlike IP BGP VPN services, however, PWE services as currently defined do not support tandem switching points. Accordingly, to establish a PWE connection, one requires a set of tunnels and a Label Distribution Protocol (LDP) session from a given end node to all other PWE nodes which share a common PWE connection. However, problems arise when the number of nodes grow in the PWE domain, and the amount of memory and processing required to set-up and maintain the tunnels increases. The result leads to scalability limitations.

Multi-Hop Pseudo Wire (MHPW) and Pseudo Wire (PW) switching are techniques which allow tandem switching points for a PWE service connection. The ability to have tandem switching points allows an unlimited number of end PWE Provider Edge (PE) nodes, while reducing the memory and processing requirements on the end service nodes.

MPLS has two general methods for distributing labels. One method is known as “flooding” wherein a copy of a label is forwarded to all LSRs. A second method is known as a “directed connection”, where a single copy is forwarded to a specific neighbor. In order for a directed connection to be made using PWE tandem switching points, the PWE member nodes required a topological view of the network. This view is used to find a neighbor in order to forward the label message which is on a shortest best path or a path which currently has the resources available to meet the requested connection requirements.

As will be appreciated by one of ordinary skill in the art, the topology of a logical network is typically independent from the underlying physical network. That is to say, only a subset of the PSN network devices participate in the logical network. For example, a direct link (PSN tunnel) in a logical network may switch through one or more PSN network devices. As a result, the topological information of the underlying network is not useful to the logical network. Furthermore, logical network devices need to distribute messages to members of the respective logical network.

While some protocols, for example, a Resource Reservation Protocol (RSVP), provide ways to restrict the use of resources within a network, these protocols do not create or identify logical networks. These protocols merely identify paths and devices through a single physical network without recognizing underlying logical networks.

One approach to solving these problems involves the use of BGP VPNs [RFC2547bis] for isolating logical topologies. One problem with this approach, however, is that market requirements mandate that the ingress and egress PWE nodes must be very inexpensive and simple such that existing staff can operate the network. The use of BGP does not meet these requirements.

Another approach so solving the aforementioned problems is to manually provision relay points. This option requires provisioning a relay point for every connection on every node it traverses. This option is difficult and expensive to engineer and maintain. Additionally, resiliency during network failures is difficult to design and implement. Therefore, a need exists for an improved network topology system and method that addresses and solves the aforementioned problems.

### SUMMARY OF THE INVENTION

The present invention advantageously provides a method and apparatus that creates a dynamic logical topology of an underlying physical communications network using identification tags representing different logical paths within the communications network.

According to an aspect of the present invention, a method for creating a logical network topology in a communication network having a plurality of network nodes is provided. The method includes establishing one or more logical paths between nodes of the communication network, and assigning one or more identification tags to each logical path. At a network node, primary layer network information is received from at least one neighboring network node, where the primary layer network information includes at least one identification tag. Upon receipt of the primary layer network information, each network node determines the network's logical topology.

According to another aspect, the present invention provides a system for creating a logical network topology in a communications network having a plurality of network nodes. The system includes one or more logical network nodes. Each logical network node contains routing circuitry for moving information between logical network nodes, and control circuitry. The control circuitry is operable to establish one or more logical paths between logical network nodes of the communications network, assign one or more identification tags to each logical path, receive primary layer network information from at least one neighboring logical network node, where the primary layer network information includes at least one identification tag, and determine a logical network topology using the primary layer network information.

According to still another aspect, the present invention provides a storage medium storing a computer program which when executed by a processing unit performs a method for creating a logical network topology in a communication network. The communications network includes a plurality of network nodes. The method performed by the computer program includes establishing one or more logical paths between nodes of the communication network, and assigning one or more identification tags to each logical path. Each network node receives primary layer network information from at least one neighboring network node, where the primary layer network information includes at least one identification tag, and determines a logical network topology using the primary layer network information.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a network topology of an MPLS network;

FIG. 2 illustrates a topology for the network in FIG. 1 in accordance with an embodiment of the present invention;

FIG. 3 illustrates logical topologies in accordance with an embodiment of the present invention;

FIG. 4 illustrates two logical network topologies utilizing a connection establishment procedure in accordance with embodiments of the present invention; and

FIG. 5 shows an MHPW Color TLV in accordance with an embodiment of the present invention.

### DETAILED DESCRIPTION OF THE PREFERRED EMBODIMENTS

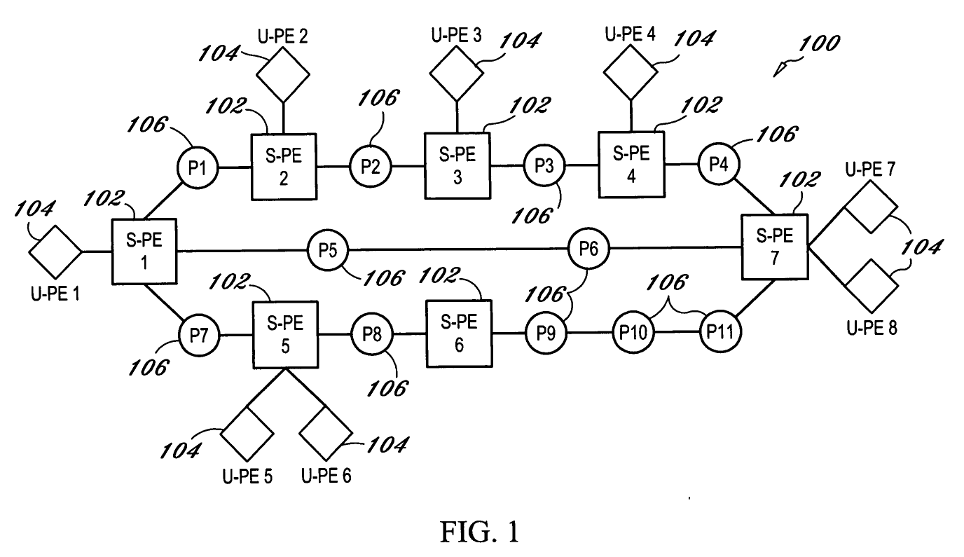

Referring now to the drawing figures in which like reference designators refer to like elements, there is shown in FIG. 1, a system constructed in accordance with the principles of the present invention. The system disclosed represents an exemplary communications network designated generally as “100”. Network 100 represents an exemplary multiservice network such as an MPLS network. Although the figures illustrate an MPLS network, the present invention may be used in any network (for example, in a network that includes pseudo wires) or network device that has a need for a logical view of resources limited to a community of interest. That is to say, the logical view may contain a subset of network element members and connectivity which may be different from the underlying connectivity of the network elements.

Network 100 includes a plurality of logical network tandem nodes 102 (shown as S-PE 1 through S-PE 7), ultimate-provider edge (U-PE) routers 104 (shown as U-PE1 through U-PE8) and label-switched routers (LSRs) 106 (shown as P1 through P11). Tandem nodes 102, situated between ingress and egress nodes in a logical network, decide the best packet forwarding route to the egress node identified in the packet being routed. U-PE routers 104 are routers in a service provider network to which customer edge (CE) routers (the routers at the customer site) are connected. LSRs 106 are routers along the Label Switch Path (LSP) that are capable of forwarding data packets based on MPLS labels. In primary communication networks, not all devices within the underlying network are knowledgeable of the logical networks therein.

A logical network typically includes a set of logical paths. In an MPLS packet-routing scheme, logical paths through the underlying network 100 form “tunnels”. MPLS networks create tunnels across the traditional IP forwarding component using labels between addressing information and the encapsulated packet. In accordance with an embodiment of the present invention, a logical topology scheme for use in a U-PE router 104 is disclosed.

Although the term “router” is used herein to refer to the network element used to transport data and/or routing information within and between nodes, it is readily understood by one of ordinary skill in the art that the present invention is not limited to such. Accordingly, the term “router” as used herein, can refer to any switching network element, such as a switch, router or any other computing device, such that the present invention is not limited to the use of routers in the traditional sense. Put another way, the term “router” is used merely for convenience herein and is not intended to limit the present invention to only traditional routing platforms. A router, such as U-PE router 104, includes suitable hardware and software to enable it to perform the functions described herein with respect to the present invention. For example, U-PE router 104 includes a central processing unit, volatile and non-volatile memory and storage devices, network interfaces and processors as well as other I/O interfaces to enable configuration.

Rather than explicitly listing by name all the PSN tunnels reserved for the exclusive use of an application, for example, i.e., an IP VPN service, or service instance, i.e. VPN Routing and Forwarding (VRF), the present invention advantageously provides a method for assigning an identification symbol or tag to each tunnel set in underlying network 100, thus providing each U-PE router 104 with information necessary to construct a logical topological view of network 112.

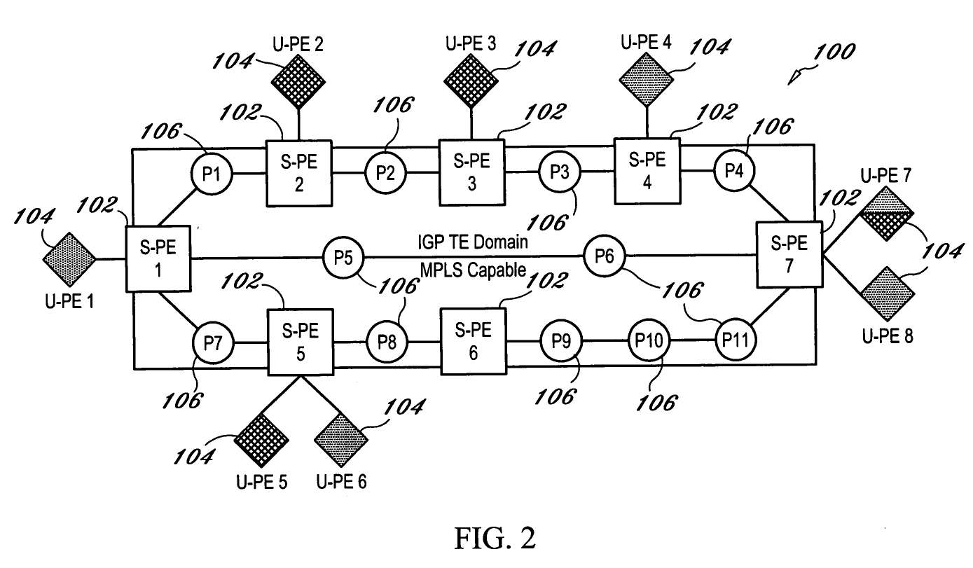

FIG. 2 shows a topology for a network 100 in FIG. 1 in accordance with an embodiment of the invention. Included in network 100 are U-PE routers 104 arranged into two sets of corresponding logical network identifiers. In FIG. 2, each U-PE router 104 is represented by an identification tag shown as a hatched pattern or a stippled pattern. The identification tag may be a color or a pattern as shown. However, notwithstanding that embodiments of the invention use color, shading or a pattern to identify logical topologies, broader embodiments of the invention are not limited in this regard.

According to embodiments of the invention, one or more pattern scheme “tags” are applied to each tunnel in underlying network 100. These tags are then distributed by the PSN network and used by the appropriate logical network nodes 102 and routers 104. “Pattern” may be represented using a single bit as the tag. However, a tag can be in any form such as a text string or a number. Patterns are used to identify PSN tunnels in the ensuing figures and discussion.

Routers 104 may be associated with no tags or one or more tags, i.e. “patterns” as shown in FIG. 2. For example, router U-PE2 and router U-PE3 are each represented by “cross-hatch” patterns, and therefore belong to the same logical network. In some instances, a router 104 may be part of more than one logical network. Router U-PE7 is such a router and therefore is represented by two patterns (“cross-hatch” and “stippled”). Thus, in certain instances, a destination logical network node (such as U-PE7) may be a member of more than one logical topology.

Patterns may be assigned to tunnels based upon various parameters. According to one embodiment of the invention, Resource Reservation Protocol (RSVP) tunnels are colored, or patterned, by name, and Label Distribution Protocol (LDP) tunnels are colored or patterned by Forwarding Equivalence Class (FEC). Furthermore, in accordance with one embodiment, the LDP label selection process as described in Internet Standards Protocol [RFC3036] is not affected by the above protocol. IP traffic is “pattern blind” and therefore will use any tunnel created unless a local policy exists limiting IP traffic from a particular set of patterns.

Each device in network 100 has IP connectivity to all other devices. Further, network 100 supports IP and MPLS forwarding supports Interior Gateway Protocol (IGP) with traffic-engineer (TE) extensions. For example, OSPF-TE [RFC3630] or IS-IS-TE [RFC3774] optionally supports RSVP-TE [RFC3473] or LDP [RFC3036] MPLS control protocols.

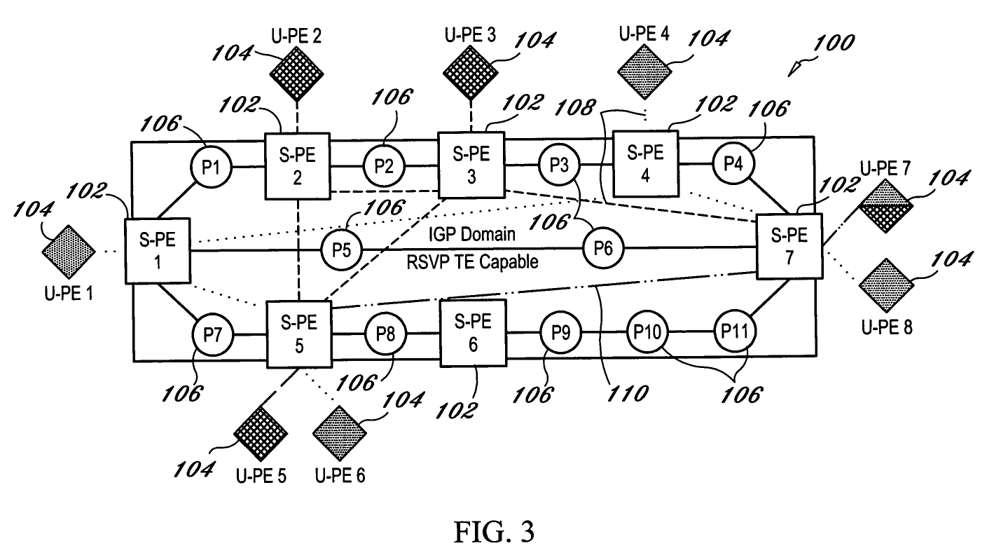

FIG. 3 illustrates a logical topology in accordance with an embodiment of the present invention. The construction of a logical topology is similar to an MPLS network topology. Connectivity between logical network nodes 102 is designed and sized using existing network design methodologies. The PSN tunnels between the logical network nodes 102 are assigned one or more patterns representing the logical topology in which they belong. A tunnel may be shared among networks or it may be used exclusively by a single logical network.

Thus, in FIG. 3, two distinct logical network topologies can be seen within underlying network 100. A first topology is indicated by dotted lines 108 between nodes 102 and routers 104. A second topology is identified by alternating dash/dot lines 110 between nodes 102 and routers 104. Each topology corresponds to a different pattern in routers 104. By receiving primary layer network information from at least one neighboring network node, each logical network tandem node 102 is able to determine the next hop or even a complete path to a destination node. Primary network information can include the destination address available from the Internal Gateway Protocol (IGP) and one or more identification tags representing a particular logical network. The next hop to an adjacent node or complete path to a destination node can be determined by, for example, using a constrained shortest path first (CSPF) algorithm. For purposes of this embodiment, a CSPF algorithm selects only the links with the color or pattern of the logical network prior to performing a typical Dykstra SPF calculation.

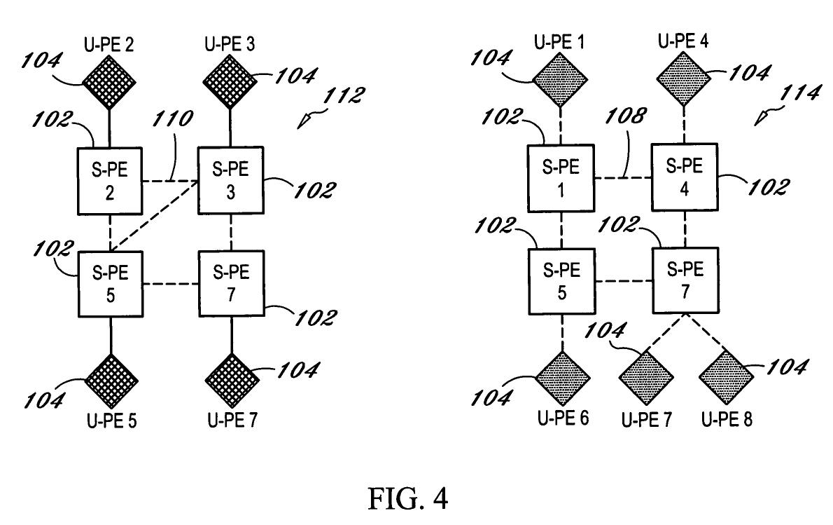

FIG. 4 shows the two logical network topologies of underlying network 100 in accordance with embodiments of the present invention. As seen in FIG. 3, two logical topologies exist within physical network 100. Separate logical tunnels are created using their respective coloring/patterns. A first logical topology 112 is identified by routers 104 having a “cross-hatch” pattern, and a second logical topology 114 is identified by routers 104 with a “dot” pattern.

Referring to FIG. 4, a connection establishment procedure in accordance with an embodiment of the invention can be seen. The cross-hatch topology 112 on the left side of FIG. 4 will be used as an example in the ensuing discussion. A U-PE service instance is provisioned with the dU-PE (destination) IP address, Pseudo-Wire ID (PWID) or Group ID (GID) and topology color/pattern. Each U-PE Router 104 builds a label mapping (LM) message with the MH PW Type/Length/Value (TLV), which specifies the sU-PE (source) and dU-PE (destination) IP addresses, and a topology color/pattern, for example, “cross-hatch” in this example. Each router 104 selects the next hop from its list of “cross-hatch” links. In this case, routers U-PE 2 and U-PE 3 each have a single link to a node 102 (node S-PE2 and node S-PE3 respectively). If either U-PE router 104 had multiple cross-hatch links, i.e., more than one node 102 in its logical network that it could route data packets to, it may resolve the next hop using the dynamic procedures described below or have a static route entry for the dU-PE address.

When node S-PE3 receives the LM message from router U-PE3, it looks at the color/pattern contained in the LM message and “prunes the routing tree” to only contain cross-hatch resources. In one embodiment, it then performs a standard SPF calculation to determine the path or next hop either from the sU-PE perspective (using the dU-PE address from the LM message and the sU-PE address as origin of the path) or the dU-PE perspective (using the sU-PE address from the LM message and the dU-PE as origin of the path). At domain boundaries, an S-PE may change its color or pattern to match the topological color or pattern in the next domain.

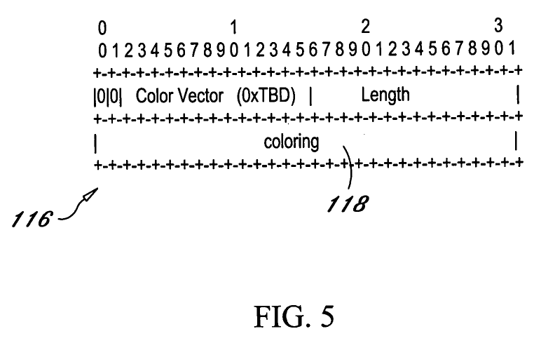

FIG. 5 illustrates an example of a generalized label format 116 in accordance with an embodiment of the present invention. A standard MH PW Color Type, Length, Value (TLV) is shown where the coloring field 118 is a bit field representing the permissible links which can be used by this connection.

In accordance with another embodiment of the present invention, a solution using PWE tandem switching is provided. In this embodiment, a PWE node is a member of IP network 100 and a member of the PWE network. The PWE IP address is advertised by the IGP of the IP domain in accordance with the existing policy within the domain. One or more colored tunnels or virtual paths are established across the IP topology from a PWE member to other members. Tunnels associated with an administrative logical network are of a particular color or pattern. This may include the ingress-to-tandem node, tandem-to-tandem nodes, and tandem-to-egress node tunnels. Connection association with a logical topology is performed at the ingress and egress PWE service nodes. No prior association knowledge is required at the tandem switching points.

When provisioning a PWE connection, the egress PE and administrative domain color are set. Both the egress PWE node IP address and the administrative domain color are included in the connection establishment signaling. The PWE node selects the next hop based on the destination PWE IP address and the administrative domain color using standard constraint enabled path selection techniques. In NH PW, the presence of the NH PW TLV indicates this message is for a logical application. Furthermore, the color within the message indicates which specific logical network is involved. Colors may be changed as they are forwarded.

To assist carriers looking to control costs and regain resources by replacing Time-Division Multiplexing (TDM) circuits with PWE connections in metro networks, the current limitation of no hops can be avoided by employing the present invention. The discovery of logical members and their connectivity is beneficial for utilizing dynamic signaling of PWE connections.

Another benefit of the present invention is that network devices, which are not members of the respective logical network, are excluded from consideration, thereby avoiding failed connections. Still another benefit of these schemes is that MPLS services may be deployed in larger networks. These schemes simplify management of logical networks and lowers the costs of maintaining them.

The association of traffic to a logical network may be based on, but not limited to, priority (e.g. emergency, business, general), application (e.g. IP BGP VPN, PWE), quality of service (e.g. voice traffic, video traffic) or any general policy. For example, during a disaster, communication networks may become overloaded and fail to provide, or block access to, emergency workers. If, however, these critical workers were using logical networks separated from the general population, the network provider would have a simple mechanism to limit, restrict or even terminate the general population traffic thereby ensuring the availability of higher priority traffic. According to another embodiment, a network operator could resell its physical resources to other network providers, by assigning each provider a unique logical network.

The present invention provides a network topology system and method whereby separate logical network topologies based on a chosen color, pattern, or other identification scheme may be identified. The logical networks are independent from the underlying primary network, and, in some instances, may overlap into other physical networks. That is, logical networks are not limited to a single underlying physical network. Similarly, a single underlying network may contain more than one logical network. Routers 104 and nodes 102 therefore need to be able to obtain information regarding the logical networks in the underlying network and construct logical network topologies, rather then be constrained by only the physical network topology of network 100.

The present invention can be realized in hardware, software, or a combination of hardware and software. An implementation of the method and system of the present invention can be realized in a centralized fashion in one computing system, or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

We claim:

1. A method for creating a logical network topology in a communications network having a plurality of network nodes, the method comprising:
establishing one or more logical paths between nodes of the communication network;
assigning one or more identification tags to each logical path; and
at a network node,
receiving primary layer network information from at least one neighboring network node, the primary layer network information including at least one identification tag; and
determining a logical network topology using the primary layer network information.

2. The method of claim 1, wherein the primary layer network information further includes at least the identity of a destination node of a logical path.

3. The method of claim 1, wherein the communication network is a PSN.

4. The method of claim 3, wherein the communication network is an MPLS network.

5. The method of claim 1, wherein the communication network is a PWE network.

6. The method of claim 5, wherein the primary layer network information includes the destination PWE IP address and at least one identification tag.

7. The method of claim 1, wherein the identification tag corresponds to a color.

8. The method of claim 1, wherein the identification tag corresponds to a number.

9. The method of claim 1, wherein the identification tag corresponds to a text string.

10. The method of claim 1, wherein the local network topology spans more than one physical communication network.

11. A system for creating a logical network topology in a communications network having a plurality of network nodes, the system comprising:
one or more logical network nodes, wherein each logical network node contains:
routing circuitry for moving information between logical network nodes; and
control circuitry operable to:
establish one or more logical paths between logical network nodes of the communications network;
assign one or more identification tags to each logical path;
receive primary layer network information from at least one neighboring logical network node, the primary layer network information including at least one identification tag; and
determine a logical network topology using the primary layer network information.

12. The system of claim 11, wherein the primary layer network information further includes at least the identity of a destination node of a logical path.

13. The system of claim 11, wherein the communication network is a PSN.

14. The system of claim 13, wherein the communication network is an MPLS network.

15. The system of claim 11, wherein the communication network is a PWE network.

16. The system of claim 15, wherein the primary layer network information includes the destination PWE IP address and at least one identification tag.

17. The system of claim 11, wherein the identification tag corresponds to a color.

18. The system of claim 11, wherein the identification tag corresponds to a number.

19. The system of claim 11, wherein the identification tag corresponds to a text string.

20. The system of claim 11, wherein the local network topology spans more than one physical communication network.

21. A storage medium storing a computer program which when executed by a processing unit performs a method for creating a logical network topology in a communication network having a plurality of network nodes, each node connected to at least one other node, the method comprising:
establishing one or more logical paths between nodes of the communications network;
assigning one or more identification tags to each logical path;
at a network node,
receiving primary layer network information from at least one neighboring network node, the primary layer network information including at least one identification tag; and
determining a logical network topology using the primary layer network information.

22. The storage medium of claim 21, wherein the primary layer network information further includes at least the identity of a destination node of a logical path.

23. The storage medium of claim 21, wherein the communication network is a PSN.

24. The storage medium of claim 23, wherein the communication network is an MPLS network.

25. The storage medium of claim 21, wherein the communication network is a PWE network.

26. The storage medium of claim 25, wherein the primary layer network information includes the destination PWE IP address and at least one identification tag.

27. The storage medium of claim 21, wherein the local network topology spans more than one physical communication network.
